(19) United States
(12) Patent Application Publication
(10) Pub. No.: US 2020/0351664 A1
(43) Pub. Date: Nov. 5, 2020

(54) SYSTEM AND METHOD FOR PERFORMING BUILDING-WIDE WIRELESS NETWORK INTRUSION DETECTION VIA CONNECTED LUMINAIRES

(71) Applicant: SIGNIFY HOLDING B.V., EINDHOVEN (NL)

(72) Inventors: ABHISHEK MURTHY, ARLINGTON, MA (US); JIN YU, LEXINGTON, MA (US)

(21) Appl. No.: 16/764,954

(22) PCT Filed: Nov. 13, 2018
(86) PCT No.: PCT/EP2018/081071

§ 371 Date: May 18, 2020

Related U.S. Application Data
(60) Provisional application No. 62/587,724, filed on Nov. 17, 2017.

(30) Foreign Application Priority Data
Dec. 7, 2017 (EP) 17205835.6

(51) Int. Cl. H04W 12/12; H04W 4/33; H04W 12/00

(52) U.S. Cl. CPC H04W 12/1201; H04W 12/00502; H04W 12/00503; H04W 4/33

(57) ABSTRACT

A method (100) and connected lighting system (10) for detecting an intruder to a wireless network (24) of a connected lighting system formed by a plurality of luminaires (14). Each luminaire receives (120), over a designated time interval, a physical layer characteristic of each client device (26) accessing the wireless network. An array (50) of reference distributions is retrieved (110) by a processor of the system. Each reference distribution corresponds to an expected distribution of the characteristics for one of the luminaires during a corresponding time interval. An observed distribution is generated (130) for each luminaire, representing an actual distribution of values of the characteristic received by one of the luminaires over the designated time interval. Each observed distribution is compared (140) to the appropriate reference distribution for the designated interval in order to detect an anomaly and initiate an alarm status.

### FIELD OF THE INVENTION

The present disclosure is directed generally to methods and systems for luminaires having wireless network interfaces that are configured to detect network intrusions.

### BACKGROUND

The ubiquity of wireless networks and ability to access them, or the information being conducted over them, without a physical connection (hence “wireless”) has made them a prime target for malicious network intrusions. The need for security is amplified as a current trend is to add wireless connectivity to an increasingly long list of devices in order to advance fields such as home/building automation, e.g., televisions, thermostats, door locks, kitchen appliances, etc.

Designated wireless security systems exist that can be installed, but these systems require additional infrastructure set up for the sole purpose of providing security. Furthermore, it may be unduly expensive in order to set up the infrastructure to create a robust security system in many locations, particularly for a large office space or commercial building.

Of particular note in combating these issues are connected lighting systems, which offer a unique feature in comparison to all other types of connected devices: lightings systems present possibly the highest density of wirelessly networkable devices of any other devices/appliance/system in a home or commercial building. That is, because light sources are already provided every few feet from each other in order to provide sufficient lighting throughout a room or building, it necessarily follows that equipping each luminaire with a wireless interface will result in a dense web of connected devices.

These connected lighting systems are traditionally useful in providing improved lighting performance within a home or commercial office (e.g., reducing electricity usage to lower overhead utility costs), with an underutilized side effect being that they create an incredibly dense mesh of wirelessly connected devices. Additionally, these connected lighting systems rely on other devices or systems to ensure that their wireless network remains secure.

Accordingly, there is a continued need in the art for methods and systems that improve wireless network security while leveraging existing building infrastructure as well as that enable the relatively dense network created by connected lighting systems to provide additional functionality traditionally unrelated to lighting systems, such as wireless network security.

### SUMMARY OF THE INVENTION

The present disclosure includes inventive methods and systems for detecting wireless network intrusion using a connected lighting system. Various embodiments and implementations herein are directed to a connected lighting system comprising a plurality of luminaires in wireless communication with each other. A reference distribution is generated with respect to each luminaire, which corresponds to an expected distribution of values of physical layer characteristics of client devices within the communication range of each luminaire during a given hypothetical time interval. A different reference distribution may be generated for each hypothetical time interval that occurs during a day, week, year, etc. The luminaires collect or otherwise receive the physical layer characteristics for each current time interval to generate an observed distribution corresponding to the actual distribution of values of the physical layer characteristics of the client devices within the communication range of each luminaire for the current time interval. In this way, both spatial (e.g., with respect to geography or location) and temporal (e.g., with respect to time) aspects are considered. The reference distributions act as a reference against which the observed distributions are compared in order to detect any anomalies between what actually occurred (the observed distributions) and what was expected to occur (the reference distributions). An alarm status is initiated if an anomaly is detected, which can result in corrective action being taken by the system, such as temporarily shutting down the wireless network. The luminaires can be arranged, e.g., with software-defined radios, in order to scan or monitor multiple different networks in the above-described manner.

Generally, in one aspect, a method is provided to detect an intruder to a wireless network formed at least partially by a plurality of luminaires connected in wireless communication. The method includes the steps of: monitoring, by network interfaces (22) of each of the plurality of luminaires in a connected lighting system (10), wireless network activity of a plurality of client devices (26); receiving (120), by the network interfaces of each of the luminaires, one or more physical layer characteristics from each of the client devices that is accessing the wireless network and is located within a geographic area (28) defined by a communication range of each luminaire over a designated time interval; retrieving (110), by a processor (20) of the connected lighting system, an array (50) of reference distributions, the array including a subset of reference distributions for each luminaire, each subset including a plurality of the reference distributions respectively corresponding to a plurality of time intervals, each reference distribution representing an expected distribution of the one or more physical layer characteristics for a corresponding one of the luminaires during a corresponding one of the time intervals from the plurality of time intervals; generating (130), by the processor of the connected lighting system, an observed distribution for each of the luminaires, each observed distribution representing an actual distribution of values of the one or more physical layer characteristics received by a given one of the luminaires over the designated time interval; comparing (140), by the processor of the connected lighting system, each observed distribution to one of the reference distributions corresponding to the designated time interval in order to detect an anomaly; and initiating (160), by the processor of the connected lighting system, an alarm status if the anomaly is detected.

According to an embodiment, the reference distributions, the observed distributions, or both, take the form of histograms. According to an embodiment, the alarm status causes the wireless network to be at least partially shut down, a message to be sent to designated personnel, creation of an audio or visual cue, or a combination including at least one of the foregoing. According to an embodiment, at least the steps of receiving, generating, and comparing repeat for one or more subsequent time intervals after the designated time interval if the anomaly is not detected. According to an embodiment, initiating the alarm status includes the step of sending an alarm signal via one or more of the luminaires to a designed network device (25) on the wireless network.

According to an embodiment, the wireless network is a first wireless network utilizing a first network protocol and the method further comprises the step of switching (330) the luminaires from the first network protocol to a second network protocol utilized by a second network, and the step of receiving is performed with respect to both the first network and the second network. According to a further embodiment, each of the luminaires includes a software-defined radio and the switching between the first and second network protocols is implemented by the software-defined radio.

According to an embodiment, the step of retrieving comprises the substeps of: defining (210) a reference learning distribution; receiving (220), by the network interfaces of each of the luminaires, one or more physical layer characteristics from each of the client devices that is accessing the wireless network and is located within the communication range of each luminaire over a current time interval; generating (220), by the processor, an observed learning distribution of the physical layer characteristics for each of the luminaires; comparing (230), by the processor, the observed learning distribution to the reference learning distribution; determining (240), by the processor, whether the reference learning distribution has stabilized based on the comparing; and defining (250) the reference distributions with data from the reference learning distribution by storing the reference distributions into a memory of the connected lighting system.

According to an embodiment, the method further comprises the substep of updating the reference learning distribution based on the observed learning distribution, and, if the reference learning distribution is determined to have not stabilized in the substep of determining, then repeating the substeps of receiving, generating, and determining.

According to an embodiment, the one or more physical layer characteristics include location-dependent characteristics, location-independent characteristics, or a combination including at least one of the foregoing. According to one embodiment, the physical layer characteristics include Received Signal Strength Indicator (RSSI), Channel-State Information (CSI), or a combination including at least one of the foregoing.

According to an embodiment, the luminaires are in communication with a network device and the network device includes the processor, the memory, or a combination of the foregoing. The method of claim 1, wherein the luminaires comprise the processor, the memory, or a combination of the foregoing.

A connected lighting system (10) for detecting an intruder to a wireless network (24) having one or more client devices (26), including: a plurality of luminaires (14) connected in wireless communication with the wireless network via network interfaces of each of the luminaires, wherein the network interfaces of each of the luminaires is configured to receive (120) values of the physical layer characteristic of each of the client devices accessing the wireless network within a geographic area (28) defined by a communication range of each luminaire over a designated time interval; a memory (18) storing an array (50) of reference distributions, the array comprising a plurality of subsets (60, 62) of the reference distributions, each subset including a plurality of the reference distributions that correspond respectively to a plurality of time intervals, each reference distribution representing an expected distribution of values of a physical layer characteristic of the client devices accessing the wireless network during a corresponding one of the time intervals; a processor (20) configured to generate (130) an observed distribution representing an actual distribution of the values of the physical layer characteristic received by the luminaire over the designated time interval, the processor also configured to compare (140) the observed distribution to one of the reference distributions corresponding to the designated time interval in order to detect an anomaly. According to an embodiment, the luminaires comprise the memory, the processor, or a combination including at least one of the foregoing.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radio luminescent sources, and luminescent polymers.

A given light source may be configured to generate electromagnetic radiation within the visible spectrum, outside the visible spectrum, or a combination of both. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The terms “lighting unit”, “lighting fixture”, or “luminaire” are interchangeably used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources.

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic illustration of a connected lighting system configured to detect an intruder to a wireless network.

FIG. 2 is a schematic illustration of a luminaire which may form a part of the connected lighting system of FIG. 1.

FIG. 3 is a schematic illustration of showing a wireless communication range or geographic area associated with a luminaire.

FIG. 4 is an example of a hypothetical distribution, in the specific form of a histogram, which may be generated and/or used by the connected lighting system of FIG. 1.

FIG. 5 is a flowchart describing one method of using a connected lighting system to detect an intruder to a wireless network.

FIG. 6 is an array of reference histograms that may be utilized by the connected lighting system of FIG. 1 and/or in the method of FIG. 5.

FIG. 7 is a flow chart describing one method of generating a reference distribution.

FIG. 8 is a flow chart describing steps that may be implemented in order to modify the connected lighting system of FIG. 1 and/or the method of FIG. 5 to monitor multiple different wireless networks for intruders.

### DETAILED DESCRIPTION OF EMBODIMENTS

The present disclosure describes various embodiments of detecting an intruder to a wireless network using a connected lighting system. More generally, Applicant has recognized and appreciated that it would be beneficial to configure a connected lighting system to collect or otherwise receive physical layer characteristics of client devices accessing the wireless network and then generate and compare various data distributions representing expected and actual distributions of the values of the physical layer characteristics. Applicant has also recognized and appreciated that it would be beneficial to consider both temporal/chronological and geographic/spatial aspects when receiving the aforementioned physical layer characteristic values and generating and comparing the aforementioned distributions. A particular goal of utilization of certain embodiments of the present disclosure is to detect an intruder to a wireless network when anomalies are detected when comparing a reference or expected distribution of physical layer characteristics of client devices to an observed or actual distribution of the physical layer characteristics of the client devices.

In view of the foregoing, various embodiments and implementations are directed to a connected lighting system comprising a plurality of luminaires in wireless communication with each other. A reference distribution is generated with respect to each luminaire, which corresponds to an expected distribution of values of physical layer characteristics of client devices within the communication range of each luminaire during a given hypothetical time interval. A different reference distribution may be generated for each hypothetical time interval that occurs during a day, week, year, etc. The luminaires collect or otherwise receive the physical layer characteristics for each current time interval to generate an observed distribution corresponding to the actual distribution of values of the physical layer characteristics of the client devices within the communication range of each luminaire for the current time interval. The reference distributions act as a reference against which the observed distributions are compared in order to detect any anomalies between what actually occurred (the observed distributions) and what was expected to occur (the reference distributions). An alarm status is initiated if an anomaly is detected, which can result in corrective action being taken by the system, such as temporarily shutting down the wireless network.

By “data distribution” or simply “distribution” as used herein, it is meant a data set representative of, or correlating to, selected characteristics of a plurality of client devices which assists in identifying patterns amongst the client devices and/or specific ones of the devices by sorting, categorizing, and/or quantifying the numbers and/or types of client devices based on their respective values of the selected characteristics. In one embodiment, the distributions discussed herein are generated by transforming data from the time domain (i.e., taken or gathered over time) into the frequency domain (i.e., the quantity/number of relevant events that occurred within a designated time interval). In one embodiment, the distributions are generated by initially taking a time series of characteristics (i.e., a series of characteristics gathered over time). In one more specific embodiment, the distribution may take the form of a histogram that categorizes the selected characteristics into different value ranges and counts the number of client devices that correspond to each value range for the selected characteristics. In one embodiment, the distribution may include performing a transformation, conversion, analysis, or other modification on a time series or other set of data, such as via a discrete wavelet transform, discrete Fourier transform, etc. in order to facilitate the quantification and/or categorization of the client devices based on the selected characteristics of the client devices. Other manners for generating distributions that may be useful in the various embodiments discussed herein will be readily recognized in view of the disclosures made herein.

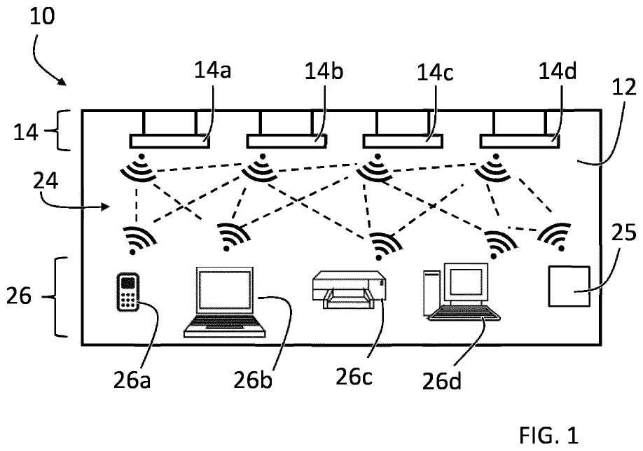

Referring to FIG. 1 a connected lighting system 10 according to one embodiment is shown for a representative workspace 12 that includes a plurality of luminaires 14. It should be understood that the workspace 12 is included to illustrate one possible embodiment of an area, space, room, building, or other location that could benefit from the embodiments disclosed herein. Essentially, the workspace 12 may take the form of any location in which it is desired to light with a number of lighting fixtures, e.g., commercial office building, manufacturing or industrial facility, warehouse, residential home, apartment building, stadium or sports facility, communal area, municipal facility or street, outdoor park, parking lot, etc.

In FIG. 1, the luminaires 14 are schematically illustrated in the form ceiling mounted lighting fixtures, but it should be understood that in other embodiments the luminaires 14 may be arranged as any suitable device (e.g., street lamps for outdoor use, floor lamps or table lamps for residential use, etc.). It is also noted that individual ones of the luminaires 14 may include an alphabetic suffix (e.g., a, b, c, etc.) appended to the numeral ‘14’ in order to facilitate discussion with respect to certain ones of the luminaires 14, however, it is to be understood that reference to the “luminaires 14” is generally applicable to all of the luminaires 14 regardless of alphabetic suffix, unless otherwise noted.

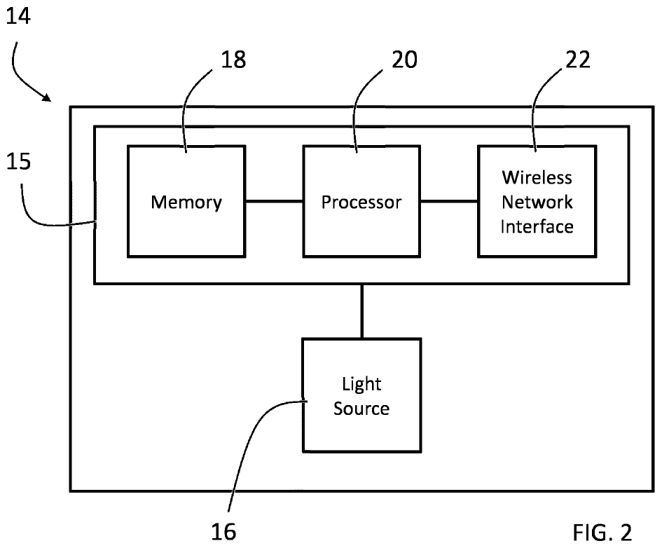

The basic components of one of the luminaires 14 according to one embodiment are shown in FIG. 2. In this embodiment, the luminaire 14 includes a controller 15 that is arranged with suitable components for controlling, monitoring, and/or otherwise assisting in the operation of a light source 16. In the illustrated embodiment, the controller 15 includes a memory 18, a processor 20, and a network interface 22. The memory 18 and the processor 20 may take any suitable form known in their respective arts that is useful for controlling and/or assisting in the operation of a light source. It is to be understood that the controller 15 is shown schematically in FIG. 2 and may include any other components useful for controlling, monitoring, and/or assisting in the operation of the light source 16.

The wireless network interface 22 may be a wireless transceiver or any other device that enables the luminaires 14 to communicate wirelessly with each other as well as other devices utilizing the same wireless protocol standard and/or to otherwise monitor network activity. In this way, and referring back to FIG. 1, the luminaires 14 are capable of forming a wireless network 24 (which may be referred to simply as the network 24). The network 24 may be understood as a wireless mesh network, in that the luminaires 14 are able to communicate with and amongst each other utilizing the network 24. In this way, the system 10 is arranged as a connected lighting system. Such systems may alternately be referred to in the art as smart lighting systems or automated lighting systems. In short, the ability of the luminaires 14 to communicate enables the system 10 to react to environmental conditions in order to more efficiently use the luminaires 14 with minimal user intervention (e.g., the system 10 “knows” to turn off selected ones of the luminaires when not needed).

The term “mesh network” as used herein means a network of devices, nodes, or clients, that is at least partially ad-hoc or decentralized, i.e., the devices, nodes and/or clients are capable of communicating directly with and/or through each other. By “at least partially” in the preceding sentence, it is to be understood that certain designated hardware such as a gateway, router, and/or other similar device, e.g., a designated network device 25, may be included to assist in providing Internet access or to otherwise control or monitor the network 24 or facilitate network communication throughout the network 24. It should be appreciated that any use of the term “communicate” as used herein does not require other devices to actively or purposely communicate with the luminaires 14, but instead may include the luminaires 14 merely monitoring the wireless activity of nearby devices as these nearby devices communicate with a gateway, router, or other network device (e.g., the network device 25). For the purposes of this disclosure, this type of monitored communication shall be considered “directly communicated” to the luminaire 14 that receives the communication. The network device 25 may include a memory, a processor, a network interface and/or any other component as taught with respect to the luminaires 14 such that the network device 25 is capable of storing data (e.g., data or data distributions such as histograms), processing commands (e.g., steps of the methods disclosed herein), and/or communicating wirelessly with the luminaires 14. Any wireless protocol that enables creation of the wireless mesh network 24 may be used, e.g., Bluetooth, Wi-Fi, Zigbee, etc.

In one embodiment, the wireless network interface 22 includes, or takes the form of, a software-defined radio. In this way, the software of the controller 15, e.g., stored in the memory 18 and implemented by the processor 20, can redefine the network protocols used by the network interface 22 such that the luminaire 14 can communicate on multiple different networks that are otherwise incommunicable with each other (e.g., the network interface 22 can switch between Wi-Fi, Bluetooth, etc., or any other network protocol). In this way, the luminaires 14 can monitor multiple different wireless networks in order to further increase the security features offered by the system 10 as discussed herein.

The wireless mesh network 24 is created by and between the luminaires 14 and a plurality of client devices designated generally with the reference numeral 26. Similar to the numbering convention used with respect to the luminaires 14, individual ones of the client devices 26 may include an alphabetic suffix (e.g., a, b, c, etc.) appended to the numeral ‘26’ in order to facilitate discussion with respect to certain ones of the client devices 26, however, it is to be understood that reference to the “client devices 26” is generally applicable to all of the client devices 26 regardless of alphabetic suffix, unless otherwise noted.

The client devices 26 also include respective network interfaces that enable them to connect to the mesh network 24 or another wireless network. In either event, the luminaires 14 are able to communicate with the client devices 26 at least to the extent that the luminaires 14 can monitor the wireless activity of the client devices 26 and/or to collect, detect, or otherwise receive certain identifying characteristics, namely physical layer characteristics, from the client devices 26, as discussed in more detail below. It is to be appreciated that whenever it is referred to that the luminaires 14 are collecting, receiving, transferring, obtaining, or sending data, signals, or information, that it is the network interfaces 22 performing these actions for the luminaires, unless otherwise stated. Also, although it is not indicated in FIG. 1, it is to be understood that the client devices 26 may communicate between and amongst each other.

The client devices 26 differ from the luminaires 14, as lighting units, are essentially permanent fixtures that are unlikely to move or be interfered with on a regular basis (e.g., ceiling fixtures that do not move and are not physically interacted with, except to change/replace a lightbulb or other light source from time to time), whereas the client devices 26 are likely to be subject to more constant change. For example, the client devices 26 may include smartphones, tablets, or other handheld computing devices (e.g., smartphone 26a); laptops (e.g., laptop 26b); printers, copiers, and other multifunctional office appliances (e.g., printer 26c); workstations and desktop computers (e.g., a workstation 26d), etc.

Dashed lines are included in FIG. 1 to indicate direct wireless communication within the network 24 (as opposed to indirect communication in which data is transferred via a chain of one or more intermediate network devices). Typically, due to the limited range of wireless communication, the devices within the network 24 that can communicate directly with each other are in relatively close physical proximity. As a result, each of the luminaires 14 can be understood as corresponding to a geographic space or area with any devices that the luminaire 14 can communicate with being located in that space. For example, in FIG. 1 the luminaire 14a is shown in direct communication with the luminaire 14b, the client device 26a, and the client device 26b, while the luminaire 14b is in direct communication with both the luminaires 14a and 14b, as well as the client devices 26a, 26b, and 26c, and so on for the luminaires 14c and 14d. It is to be appreciated that this is merely one example and each luminaire 14 may be connected to any number of other luminaires or of the client devices 26.

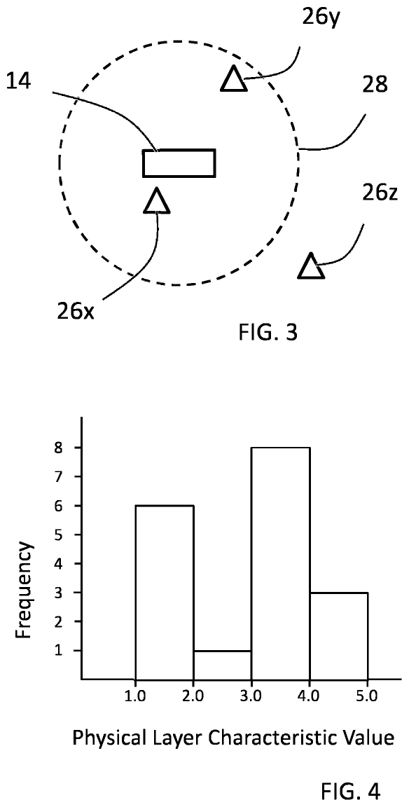

FIG. 3 illustrates an embodiment in which one of the luminaires 14 is shown surrounded by its corresponding geographic area 28, which may alternatively be understood as the signal or communication range of the luminaire 14. The geographic area 28 thus represents the bounds within which a device, e.g., one of the client devices 26 or another of the luminaires 14, must be located in order to directly communicate with the luminaire corresponding to that geographic area. Alternatively stated, the geographic area 28 represents the communication range of the corresponding luminaire 14. For example, in FIG. 3, three client devices 26x, 26y, and 26z are illustrated. The client devices 26x and 26y are both within the geographic area 28 and thus can communicate directly with the luminaire 14 in FIG. 3, but the 26z is outside of the geographic area so it cannot. Additionally, the devices 26x and 26y may result in contrasting values of their respective physical layer characteristics that may indicate that the device 26x is in relatively closer proximity to the luminaire 14 than the device 26y.

It is to be understood that FIG. 3 is a schematic two dimensional image, but that the geographic area of the luminaires 14 would in reality extend in three dimensions. Additionally, while the geographic area 28 is illustrated as a circle (which would become spherical when extended in three dimensions), each geographic area 28 in actual practice would likely take a more amorphous shape and be affected by such things as signal interference from other sources (e.g., other wireless networks), physical obstructions (e.g., walls), and other factors.

According to some aspects, one or more antennas or antenna arrays may be included by the system 10 in order to increase the accuracy of identifying or pinpointing the location or position of the client devices 26 with respect to the luminaires 14. For example, as discussed above with respect to the client devices 26x and 26y, a luminaire may be able to determine that one of the client devices is relatively closer to that luminaire than the other client device. However, without the aid of one or more antennas, the luminaires may not be able to detect in which direction or directions the client devices 26 are positioned. This may be particularly advantageous in embodiments in which the workspace 12 is a particular room, building (e.g., house or office), etc., and the client devices 26 are determined to be accessing the network 12 from outside of this room or building, etc.) since this type of activity is more suspicious (i.e., more likely to be an intruder) than if client devices 26 are accessing the network 24 from within the room, building, etc.

According to one embodiment, each of the luminaires 14 monitors or scans (these terms are used generally interchangeably herein) the network 24 in its corresponding geographic area 28 in order to collect, detect, or otherwise receive (these terms are used generally interchangeably herein) certain physical layer characteristics from all of the client devices 26 located within the geographic area 28 with which that luminaire can directly communicate via its network interface 22. By “receive certain physical layer characteristics” it is meant that a signal, data, information, or values corresponding to the physical layer characteristics is received by the network interface 22 of each of the luminaires 14. The physical layer characteristics may include computed location-dependent characteristics or values such as Received Signal Strength Indicator (RSSI) or Channel-State Information (CSI). By “location-dependent” it is meant that the value changes depending on relative location of the client devices 26 with respect to the luminaires 14.

The physical layer characteristics may alternately or additionally include location-independent characteristics that can be used to identify the wireless device. For example, it is known that many wireless transceivers or other network interfaces exhibit unique behavior or signatures under certain operating conditions. Commonly, this type of device signature is based on imperfections or quirks in the specific manufacturing processes used to create the device. For example, transceivers or other network interfaces may manifest a unique pattern of radio frequency output during the initial few seconds after turning the device on. This unique signal pattern can be used as, or turned into, a “signature” useful in identifying the corresponding device. In one embodiment, the signal pattern data is a time-domain signal (amplitude and phase) and is manipulated into a signature by taking a discrete wavelet transform of the data and using the calculated coefficients as a unique identifying feature. Other mathematical conversions, such as Fourier transforms, may similarly be used to create identifying signatures from behavioral characteristics of the client devices 26, such as the aforementioned unique “turn on” signal pattern. It is not uncommon for companies and internet security groups to keep lists of so called “black-listed” devices that are identified based on this type of location-independent characteristic or signature. Those of ordinary skill in the art will appreciate that these are just a few examples and recognize other location-dependent and location-independent characteristics that could be monitored by the luminaires 14.

The luminaires 14 are configured to perform the scanning over one or more designated time intervals. One or more data distributions (or each simply a “distribution”) are generated corresponding to each such time interval, with each distribution quantifying the number and/or type of client devices 26 monitored by each luminaire in its corresponding geographic area 28. For example, in one embodiment the distributions take the form of histograms and the client devices 26 are sorted by the number of the client devices 26 that have values for their physical layer characteristic(s) that fall into different designated value ranges. In other words, the distributions represent the values of the physical layer characteristics of the client devices 26 within the communication range of any given luminaire 14.

FIG. 4 illustrates a representative histogram that counts or tallies the number (“Frequency”) of devices having a value of the selected physical layer characteristic that falls into one of four value ranges (i.e., six devices having a physical layer characteristic value between 1.0 and 2.0, one device having a value between 2.0 and 3.0, eight devices having a value between 3.0 and 4.0, and three devices having a value between 4.0 and 5.0). Those of ordinary skill in the art will readily recognize that FIG. 4 is just one hypothetical example of a histogram that does not correspond to any particular physical layer characteristic, and thus that any physical layer characteristic (e.g., RSSI, CSI, etc.) may be monitored in this manner and grouped into any number of relevant value ranges in order to create histograms for any number of luminaires.

Those of ordinary skill in the art will recognized that histograms, e.g., as shown in FIG. 4, are just one example of a data distribution that can be utilized by the disclosed embodiments. For example, in one embodiment the distribution may take the form of a time series of the physical layer characteristics (i.e., a series of the physical layer characteristics gathered over time). In further embodiments, the distribution may include performing a transformation, conversion, analysis, or other modification on a time series or other set of data, such as via a discrete wavelet transform, discrete Fourier transform, etc. Other types of distributions that may be useful in the various embodiments discussed herein will be readily recognized in view of the disclosures made herein.

The scanning by the luminaires 14 akin to that described above may occur in multiple different phases of various embodiments disclosed herein in order to generate two types of distributions, referred to herein as “reference” distributions and “observed” distributions. The terms “reference” and “observed” are used merely for convenience in describing various embodiments herein and their respective dictionary definitions should not be considered limiting in any way to the disclosed or claimed embodiments.

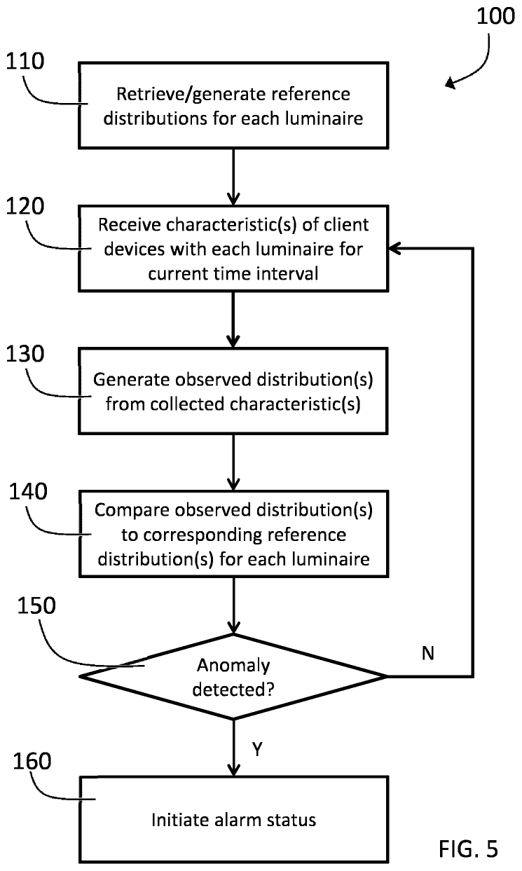

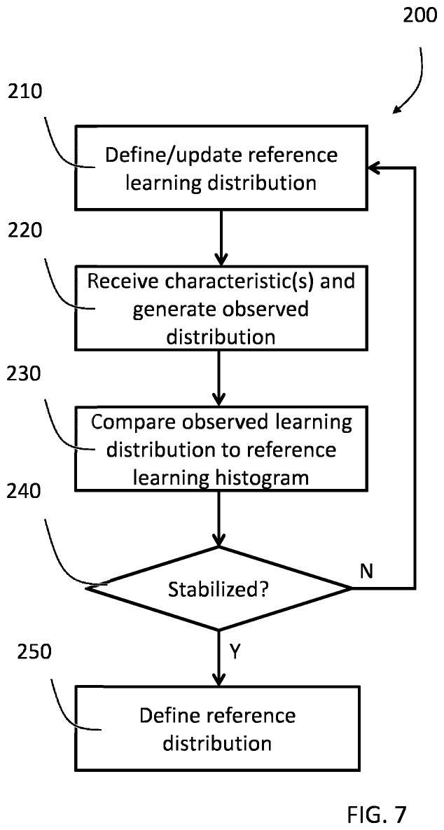

To better understand the various embodiments disclosed herein, FIG. 5 is provided which includes a flowchart that depicts a method 100 to detect an intruder to a wireless network according to one embodiment. Starting at step 110 of the method 100, an array of reference distributions is generated or otherwise retrieved or obtained. In one embodiment, the array of reference distributions is generated during a learning phase, which is described below with respect to method 200 in FIG. 7. Ultimately, the purpose the reference distributions is to provide a baseline or historical distribution of client devices that are expected to be detected by each of the luminaires at a hypothetical time within a given day, week, month, year, etc. That is, it is generally accepted that human beings, particular in a working environment, are “creatures of habit” or otherwise subject to regular routines and therefore, it is expected that certain patterns will emerge that can be captured by, or appreciated in light of, the reference distributions.

For example, in one embodiment, a reference distribution may be created that corresponds to the time interval of “10:00 am to 11:00 am”, which would be applicable to any given day. That is, when used by the system 10, this reference distribution would indicate the types and number of the client devices 26 that the corresponding one of the luminaires 14 should expect to encounter on any given day between the hours of 10:00 am and 11:00 am. In another embodiment, a reference distribution may be created that corresponds to the time interval of “Tuesdays from 4:00 pm to 4:30 pm”, which would indicate what one might expect on any given Tuesday during the half-hour interval at this time. As another example, a reference distribution may correspond to the “First Monday in January from 6:05 am to 6:10 am”, which would be applicable for the five minute interval on this particularly day and month each year.

Additional reference distributions may be generated to complete a full chronology so that any given case has a reference distribution associated with it. For example, in the first example in the preceding paragraph (“10:00 am to 11:00 am”), twenty-three other reference distributions could similarly be generated (a total of twenty-four one-hour long time intervals) to cover each of the remaining hour long time intervals to create a full chronology of one day. Similarly, in the second example of the preceding paragraph (“Tuesdays from 4:00 pm to 4:30 pm”) three hundred and thirty five more reference distributions could similarly be generated (a total of three hundred and thirty six time intervals of thirty minutes each, in order to create a full chronology of one week). The reference distributions can be as granular (shorter and/or more time intervals) or as broad (longer and/or fewer time intervals) as desired, depending on the particular needs of the user of the connected lighting system 10. It is also noted that a partial chronology could be created instead of a full chronology (e.g., scanning does not take place during certain time periods where scanning is not feasible or desirable). Additionally it is noted that the time intervals do not need to be consistent in length when creating a chronology (e.g., a longer time interval could be used when increased granularity is not as necessary, such as over weekends or late at night when there is less network traffic to scan).

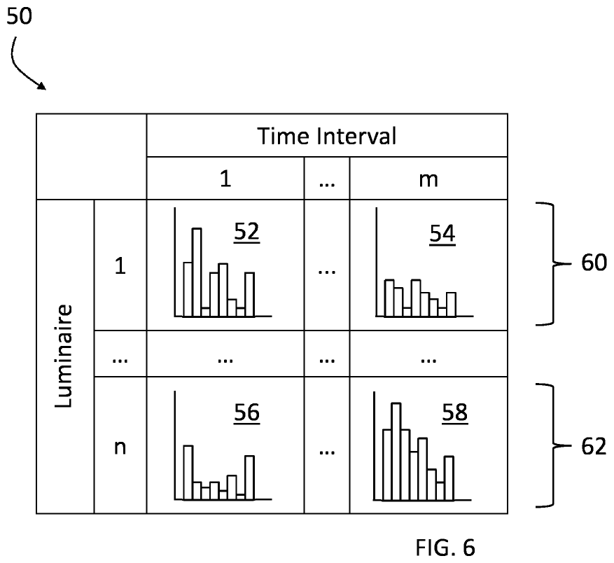

FIG. 6 depicts an array 50 of reference distributions for any number of luminaires (i.e., from 1 to ‘n’ luminaires, with ‘n’ being any integer greater than 1) and any number of designated time intervals (i.e., from 1 to ‘m’ time intervals, with ‘m’ being any integer greater than 1). That is, with respect to the embodiment of FIG. 6 a reference histogram 52 is stored for a first luminaire (Luminaire ‘1’) during the first time interval (Time Interval ‘1’), a reference histogram 54 is stored for the first luminaire (Luminaire ‘1’) during an “mth” time interval (Time Interval ‘m’), a reference histogram 56 is stored for an “nth” luminaire (Luminaire ‘n’) during the first time interval (Time Interval ‘1’), and a reference histogram 58 is stored for the “nth” luminaire (Luminaire ‘n’) during the mth time interval (Time Interval ‘m’). It is again noted that histograms, e.g., the histograms 52, 54, 56, and 58, are just one example of a distribution that may be used and that other data distributions may be similarly stored in arrays such as the array 50.

In this way, a subset of distributions covering all of the designated time intervals is stored for each of the luminaires, i.e., a subset 60 for the first luminaire (Luminaire ‘1’) and a subset 62 for the nth luminaire (Luminaire ‘n’). Since the type and number of client devices 26 may change throughout the day (e.g., as users enter, exit, and move throughout a building during the day), the array 50 can be configured to store a different reference distribution for each luminaire during any number of different designated time intervals. It is noted that the array 50 may not be stored in its entirety in the same place, e.g., each of the subsets (e.g., 60, 62, etc.) may be stored in the memory 18 of the respective luminaire 14 to which that subset corresponds. Alternatively, the entirety of the array 50 may be stored in memory on another network device, e.g., the network device 25.

In contrast to a reference distribution, an “observed” distribution refers to a distribution that is actually observed for a discrete time period on a particular date and not a hypothetical situation or expectation. To this end, at step 120 of the method 100, physical layer characteristics are received by each of the luminaires from the client devices within their communication range for the current or designated time interval. The step 120 can be performed essentially in real-time, that is, during a current time interval such that the luminaires monitor the actual physical layer characteristics of the client devices at that moment in time. At the end of the current time interval, the observed distributions are generated from the physical layer characteristics received at a step 130. This generation may be performed by the processors 18 of each of the luminaires 14, or the luminaires 14 may transfer the collected physical layer characteristic data to another network device, e.g., the network device 25, for generation of the observed distributions.

For example, an observed distribution may correspond to physical layer characteristics of client devices actually scanned during the time period of 10:00 am to 11:00 am on a particular date, (e.g., Jan. 1, 2018; Mar. 3, 2022, Jul. 4, 2019; or any other date) while the reference distribution simply corresponds to the general case of “10:00 am to “11:00 am” for any given day. In this way, the observed distributions may be generated in essentially real-time to quantify what is actually happening (and/or has just happened) and compared to what is, or was, hypothetically expected based on historical trends.

At a step 140, the observed distributions are compared to the corresponding reference distributions. By comparing what is actually happening (the observed distributions) to what was expected to happen (the reference distributions), anomalies or deviations from what is expected can be identified. Any known metric or technique for comparing distributions can be used to analyze the distributions, e.g., Kullback-Leibler or Bhattacharya distances, etc. The comparing may be performed individually by each of the processor 20 of each luminaire 14, or the relevant data may be transferred to another network device, e.g., the network device 25, to perform the comparison.

At a step 150, it is determined whether an anomaly was detected, with the method returning back to the step 120 if there is no anomaly and proceeding to a step 160 if an anomaly is detected. It is to be understood that the system can be configured such at minor deviations or anomalies under a certain threshold result in a “No” in the step 150, which returns the method back to the step 120. If returned to the step 120, the method repeats for the next time interval and each subsequent time interval thereafter (i.e., each new time interval becoming the current time interval).

Since such an anomaly represents a deviation from what is expected based on historical trends, any anomaly may be the result of an unwanted intruder gaining access to the network 24. Accordingly, the system 10 may be configured to initiate an alarm status at step 160 upon identification of an anomaly. The alarm status can correspond to any number of different corrective actions that are undertaken in response. For example, in one embodiment the system 10 is configured to completely disable the network 24 upon initiation of the alarm status in order to frustrate the attempts of any intruders into the system. In one embodiment, the alarm status is initiated by one or more of the luminaires 14 sending an alarm signal throughout the network 24. The alarm signal may ultimately be received by a gateway, server, router, or other designated device controlling and/or monitoring the network 24, e.g., the network device 25. In one embodiment, the system 10 is configured to disable just the portion of the network 24 in the geographic area corresponding to the anomaly. In one embodiment, a message or alert (e.g., via email, SMS, etc.) is sent to personnel in charge of the network 24 (e.g., IT or security). In one embodiment, the system 10 produces a visual or audio cue, e.g., in a designated area staffed by IT and/or security personnel such that further investigative action can occur. These later examples may be more appropriate for networks and workspaces that are excessively chaotic or experience an extremely high degree of network traffic and client device changes, which may cause a system to generate a relatively greater number of “false positives”, since they create an actionable event for a human to investigate further without immediately affecting the performance of the wireless network. Those of ordinary skill in the art will recognize other corrective actions that a connected lighting system may take upon detection of an anomaly.

The system 10, when operating as discussed above, is able to detect relatively small deviations in client behavior because the distributions consider both spatial and temporal variables, that is, the distributions are generated with respect to both geography and chronology. That is, the luminaires 14 each correspond to a specific geographic area 28 and the distributions (both reference and observed) each correspond to a specific time or chronology. Even if only location-independent characteristics are collected from the client devices 26 from the luminaires 14, geographic information with respect to the client devices 26 is still obtained since each luminaire 14 only collects information about the physical layer characteristics of the client devices 26 actually within its communication range, i.e., within the geographic area 28. Advantageously, this granularity of both geography and chronology enables the system 10 to account for environments that are in constant flux, e.g., a busy commercial office in which users are entering, exiting, and moving around with their client devices, and thereby increases the likelihood that an intruder is successfully identified. In other words, it does not matter how many client devices 26 are involved with the network 24, or if this number of devices changes each day and/or throughout the day, since the system 10 can be configured to accommodate these changes in the client devices 26 as discussed above.

In one embodiment, the step 110 may be carried out in accordance with a method 200 illustrated in FIG. 7. The method 200 starts at a step 210 in which a reference learning distribution is defined or updated. Similar to “reference” and “observed”, the phrase “learning” is used herein for convenience only and should not be considered limiting in any way. The term “reference learning” distribution refers to a reference distribution that is “learning” or being “trained” during the learning phase, but again this phrase is used for convenience only and should not be considered limiting in any way. Initially, the reference learning distribution has not yet learned anything and is blank. At a step 220, physical layer characteristics are collected for a current time interval and an observed learning distribution is generated in accordance with any of the relevant methods described above (e.g., as discussed with respect to the step 120 and 130). By “observed learning” it is meant an observed distribution used during the learning phase, and again, this phrase is used herein for convenience only and should not be considered limiting in any way. Next, the observed learning distribution is compared to the reference learning distribution at a step 230. The comparison in the step 230 to identify whether the reference learning distribution has converged or stabilized at a step 240, i.e., has gathered enough data to accurately predict and/or correspond to the results of the observed learning distribution.

If the reference learning distribution has not stabilized, the method 200 returns back to step 210 where the reference learning distribution is updated based on the previous observed learning distribution and the results of the comparison of step 230. If the reference learning distribution is determined to have stabilized, the method 200 can proceed to a step 250 in which the reference distribution is defined as the final iteration of the reference learning distribution. The method 200 can be repeated for each reference distribution that must be generated. In order to ensure a sufficient level of accuracy in the generated reference distributions, the step 240 may result in a “No” until the method undergoes a certain minimum number of cycles and/or the comparison in step 230 shows accurate results at least a minimum number of times. It is also noted that the learning phase described by the method 200 may in some embodiments be used at any time to update the reference distributions, e.g., particularly if the reference distributions become outdated and/or begin generating an undesirable number of “false positive” alarms.

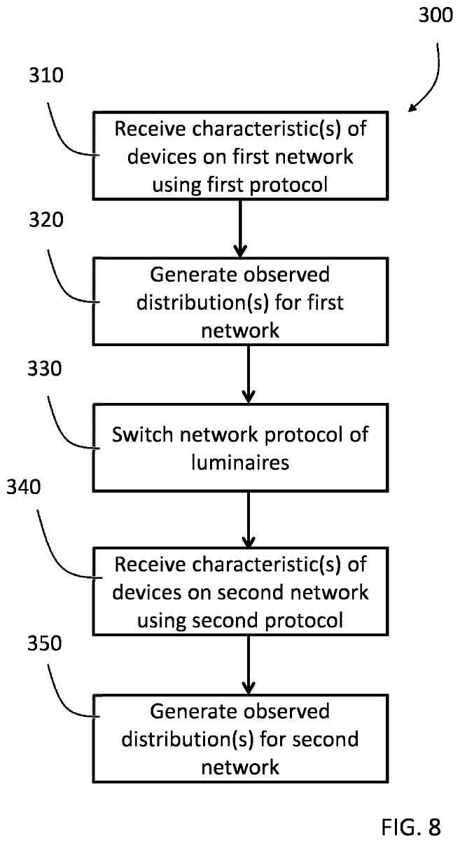

In embodiments in which the luminaires 14 are capable of communicating on different networks (e.g., wherein the network interfaces 22 are or include software-defined radios as discussed above), the method of operation can be modified to scan multiple networks. For example, FIG. 8 illustrates a portion of a partial method 300, which can be used to substitute the steps 120 and 130 in the method 100. In the partial method 300, a step 310 and a step 320 closely resemble the steps 120 and 130, respectively, which the steps 310 and 320 essentially replace. However, the steps 310 and 320 are performed with respect to a first network utilizing a first network protocol. The step 320 proceeds to a step 330 in which the network interface of each luminaire switches network protocols to monitor a second network. For example, this may be accomplished by using a second wireless transceiver or by using a software-defined radio as discussed above. In any event, steps 340 and 350 follow, which also generally resemble the steps 120 and 130 and/or the steps 310 and 320, except that the steps 340 and 350 are performed with respect to the second network. If substituted for the steps 120 and 130, the step 350 would then proceed to the step 140 and follow the other steps of the method 100. Alternatively, similar steps to the method 300 can be utilized to switch between any number of different network protocols. Additionally, it is noted that the steps of the method 300 may be combined with the steps of the method 100 in other orders, as desired (e.g., step 140 occurs both before step 330 and again after step 350).

In one embodiment, the luminaires 14 are configured to collaborate with each other in order to increase the likelihood of properly identifying an intruder and/or decrease the likelihood of identifying “false positives”. For example, in one embodiment the system 10 is arranged to verify the anomaly and/or to see if the anomaly can be rectified by collaborating information from multiple of the luminaires 14. If the anomaly is rectified, then the system 10 can be arranged not to initiate the alarm status. For example, a client device may be flagged as causing an anomaly since it is detected as being in a geographic location at a time that it normally is not, e.g., as determined by comparing the relevant reference distribution (which does not include this client device in this location at this time), to the actual observed distribution (which detected this client device as actually being in this location at this time). In this example embodiment, the luminaire 14 that detects the anomaly can communicate with the other luminaires 14 in order to “ask” them if they “recognize” the client device 26 causing the anomaly. For example, as discussed above, each of the client devices 26 may have a unique signature or other location-independent characteristics that are tracked by the luminaires 14. The location-independent characteristic of the anomalous client device can therefore be communicated to the other luminaires to see if the anomalous client device is a known device that is usually in another location at this time. If the anomalous device is “recognized”, the system 10 may be configured to rectify the anomaly and therefore not initiate the alarm status.

In view of the foregoing paragraph, in one embodiment, the network device 25 is arranged to monitor for anomalies on a “macro” level (e.g., the entirety of the workspace 12) by initiating the alarm status only if the anomaly cannot be rectified by the network device 25, while each of the luminaires 14 is arranged to detect anomalies on the “micro” level (e.g., within the corresponding geographic area 28 of each of the luminaires 14). In other words, the anomalies detected by the luminaires 14 in this embodiment are only considered anomalies at the “macro” or system level if they cannot be rectified. Those of ordinary skill in the art will recognize other manners in which the luminaires 14 and/or network device 25 can communicate in order to verify, rectify, or otherwise more accurately identify anomalies.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of,” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of detecting an intruder to a wireless network formed at least partially by a plurality of luminaires connected in wireless communication, the method comprising the steps of:
monitoring, by network interfaces of each of the plurality of luminaires in a connected lighting system, wireless network activity of a plurality of client devices;
receiving, by the network interfaces of each of the luminaires, one or more physical layer characteristics from each of the client devices that is accessing the wireless network and is located within a geographic area (28) defined by a communication range of each luminaire over a designated time interval;
retrieving, by a processor of the connected lighting system, an array of reference distributions, the array including a subset of reference distributions for each luminaire, each subset including a plurality of the reference distributions respectively corresponding to a plurality of time intervals, each reference distribution representing an expected distribution of the one or more physical layer characteristics for a corresponding one of the luminaires during a corresponding one of the time intervals from the plurality of time intervals;
generating, by the processor of the connected lighting system, an observed distribution for each of the luminaires, each observed distribution representing an actual distribution of values of the one or more physical layer characteristics received by a given one of the luminaires over the designated time interval;
comparing, by the processor of the connected lighting system, each observed distribution to one of the reference distributions corresponding to the designated time interval in order to detect an anomaly; and
initiating, by the processor of the connected lighting system, an alarm status if the anomaly is detected.

2. The method of claim 1, wherein the reference distributions, the observed distributions, or both, take the form of histograms.

3. The method of claim 1, wherein the alarm status causes the wireless network to be at least partially shut down, a message to be sent to designated personnel, creation of an audio or visual cue, or a combination including at least one of the foregoing.

4. The method of claim 1, wherein at least the steps of receiving, generating, and comparing repeat for one or more subsequent time intervals after the designated time interval if the anomaly is not detected.

5. The method of claim 1, wherein the wireless network is a first wireless network utilizing a first network protocol and the method further comprises the step of switching the luminaires from the first network protocol to a second network protocol utilized by a second network, and the step of receiving is performed with respect to both the first network and the second network.

6. The method of claim 5, wherein each of the luminaires includes a software-defined radio and the switching between the first and second network protocols is implemented by the software-defined radio.

7. The method of claim 1, wherein initiating the alarm status includes the step of sending an alarm signal via one or more of the luminaires to a designed network device on the wireless network.

8. The method of claim 1, wherein the step of retrieving comprises the substeps of:
defining, a reference learning distribution;
receiving, by the network interfaces of each of the luminaires, one or more physical layer characteristics from each of the client devices that is accessing the wireless network and is located within the communication range of each luminaire over a current time interval;
generating, by the processor, an observed learning distribution of the physical layer characteristics for each of the luminaires;
comparing, by the processor, the observed learning distribution to the reference learning distribution;
determining, by the processor, whether the reference learning distribution has stabilized based on the comparing; and
defining the reference distributions with data from the reference learning distribution by storing the reference distributions into a memory of the connected lighting system.

9. The method of claim 8, further comprising the substep of updating the reference learning distribution based on the observed learning distribution, and, if the reference learning distribution is determined to have not stabilized in the substep of determining, then repeating the substeps of receiving, generating, and determining.

10. The method of claim 1, wherein the one or more physical layer characteristics include location-dependent characteristics, location-independent characteristics, or a combination including at least one of the foregoing.

11. The method of claim 1, wherein the physical layer characteristics include Received Signal Strength Indicator (RSSI), Channel-State Information (CSI), or a combination including at least one of the foregoing.

12. The method of claim 1, wherein the luminaires are in communication with a network device and the network device includes the processor, the memory, or a combination of the foregoing.

13. The method of claim 1, wherein the luminaires comprise the processor,
the memory, or a combination of the foregoing.

14. A connected lighting system for detecting an intruder to a wireless network having one or more client devices, comprising:
a plurality of luminaires connected in wireless communication with the wireless network via network interfaces of each of the luminaires, wherein the network interfaces of each of the luminaires is configured to receive values of the physical layer characteristic of each of the client devices accessing the wireless network within a geographic area defined by a communication range of each luminaire over a designated time interval;
a memory storing an array of reference distributions, the array comprising a plurality of subsets of the reference distributions, each subset including a plurality of the reference distributions that correspond respectively to a plurality of time intervals, each reference distribution representing an expected distribution of values of a physical layer characteristic of the client devices accessing the wireless network during a corresponding one of the time intervals; and
a processor configured to generate an observed distribution representing an actual distribution of the values of the physical layer characteristic received by the luminaire over the designated time interval, the processor also configured to compare the observed distribution to one of the reference distributions corresponding to the designated time interval in order to detect an anomaly.

15. The system of claim 14, wherein the luminaires comprise the memory, the processor, or a combination including at least one of the foregoing.
